(19) United States
(12) Patent Application Publication
(10) Pub. No.: US 2025/0245292 A1
(43) Pub. Date: Jul. 31, 2025

(54) APPROXIMATING A SEGMENT COUNT FOR A NORMALIZED DATASET USING SAMPLING

(71) Applicant: Salesforce, Inc., San Francisco, CA (US)

(72) Inventors: Vivek Patangiwar, Bangalore (IN); Deepak Pushpakar, BANGALORE (IN); Rohit Narayan, Bengaluru (IN); Samyak Jain, Haridwar (IN)

(73) Assignee: Salesforce, Inc., San Francisco, CA (US)

(21) Appl. No.: 18/427,668

(22) Filed: Jan. 30, 2024

(51) Int. Cl. G06F 17/18

(52) U.S. Cl. CPC G06F 17/18

(57) ABSTRACT

A method to approximate a segment count for a normalized dataset. The method includes sampling items in the primary database object to generate a sample, executing a segmentation count query on the sample to determine how many items in the sample satisfy a set of segment criteria, determining an error value based on an estimated sample size of the sample, a number of items in the sample that satisfy the set of segment criteria, and a confidence level value, determining a range of counts for the segment count based on the number of items in the sample that satisfy the set of segment criteria, the error value, and a total number of items in the primary database object, and providing the range of counts representing an approximated segment count for the normalized dataset.

### TECHNICAL FIELD

One or more implementations relate to the field of databases, and more specifically, to approximating a segment count for a normalized dataset stored in a database using sampling.

### BACKGROUND

A normalized dataset may include data that is spread across multiple database tables (logically or physically), often to reduce redundancy. The normalized dataset may be organized using a primary database object and one or more auxiliary database objects (e.g., a star schema). The primary database object (e.g., which may be a relational database table) may include multiple items and the one or more auxiliary database objects (which may also be relational database tables) may include data relating to the items in the primary database object. The items may represent a real-world entity or concept. For example, in the context of a database for a customer relationship management (CRM) system, the items may represent customers or prospective customers of a company.

A segment is a subset of items that satisfy a specified segment criteria. It is often desirable to count the number of items in a particular segment (also referred to as performing a segment count). For example, a sporting goods company using a CRM system may wish to count the number of customers that have purchased at least one golf club in the last three months and that have also performed an online search that included the term “golf club.” Performing a segment count may involve joining data from many tables, applying filters on joined data, computing aggregations, applying filters on aggregations, and counting the number of resulting items. Performing a segment count can be computationally expensive and time-consuming, especially when the data of the dataset is distributed across many tables, each having many rows.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram showing an environment in which a segment count for a normalized dataset can be approximated using sampling, according to some implementations.

FIG. 2 is a diagram showing operations involved in executing a segmentation count query, according to some implementations.

FIG. 3 is a diagram showing ways to determine the error due to sampling and the range of counts, according to some implementations.

FIG. 4 is a flow diagram of a method for approximating a segment count for a normalized dataset using sampling, according to some implementations.

FIG. 5A is a block diagram showing an electronic device, according to some implementations.

FIG. 5B is a block diagram showing a deployment environment, according to some implementations.

### DETAILED DESCRIPTION

The following description describes implementations for approximating a segment count for a normalized dataset using sampling. As mentioned above, performing a segment count for a normalized dataset may be computationally expensive and time-consuming, especially when the data is distributed across many tables, each having many rows.

Implementations provide a segment count service that is able to approximate a segment count based on sampling the normalized dataset and executing a segmentation count query on the sample, instead of executing a segmentation count query on all items. According to some implementations, the segment count service may receive a request for a normalized dataset for a specified set of segment criteria. The normalized dataset may be organized using a primary database object and one or more auxiliary database objects (e.g., in a relational database or other type of database). The set of segment criteria may include one or more criteria for the items that are to be included in the segment. Responsive to receiving the request, the segment count service may sample items in the primary database object to generate a sample. The segment count service may execute a segmentation count query on the sample to determine how many items in the sample satisfy the set of segment criteria. Executing the segmentation count query may involve joining items in the sample with data in the one or more auxiliary database objects. The segment count service may determine an error value based on an estimated sample size of the sample, a number of items in the sample that satisfy the set of segment criteria, and a confidence level value. The segment count service may determine a range of counts for the segment count based on the number of items in the sample that satisfy the set of segment criteria, the error value, and a total number of items in the primary database object. The segment count service may provide the range of counts as a response to the request. The range of counts may represent an approximated segment count for the normalized dataset for the specified set of segment criteria, with a confidence level corresponding to the confidence level value (e.g., if the confidence level value corresponds to a confidence level of 95%, then the actual segment count is expected to lie within the range of counts 95% of the time).

Advantageously, implementations can be used to quickly approximate a segment count for a normalized dataset for a specified segment criteria. That is, implementations can quickly perform a segment count in exchange for losing some accuracy. The use of implementations may be particularly advantageous for situations where a user performs multiple segment counts on a large normalized dataset and does not need the exact segment counts-approximations of the segment counts are sufficient. For example, the use of implementations may be particularly advantageous for a company using a customer relationship management (CRM) system that wishes to target an email advertisement campaign at a particular segment of users (e.g., including its past/current customers and/or prospective customers). The company may have a rough idea of the segment criteria for the segment and the size of the segment. The company may iteratively query the CRM database using different segment criteria and perform a count to determine the size of the segment for the different segment criteria, until the company finds a segment criteria that yields a satisfactory segment size. The resulting segment counts act as a feedback loop that allows the company to further fine tune the segment criteria. If the size of the dataset is large, executing these successive queries can be computationally expensive and time-consuming. This results in slow turn-around times for users performing segment counts. Implementations speed up the segment count process while still providing an estimate of the actual segment count with some level of confidence, which may be acceptable for many use cases. Implementations may be advantageous for an interactive querying use case such as the one mentioned above, where a user wishes to perform several successive segment counts, fine tuning the set of segment criteria with each iteration.

One existing approach to approximating query counts is to use a stratified sampling approach (e.g., BlinkDB). However, this approach requires preprocessing and caching the dataset so it is only suitable for constrained environments where the dataset is known in advance and is not expected to change frequently. In contrast, implementations described herein do not require preprocessing and caching the dataset and thus are more convenient and suitable for use with datasets that are not known in advance and/or that are expected to be updated/changed frequently.

Implementations will now be described with reference to the accompanying figures.

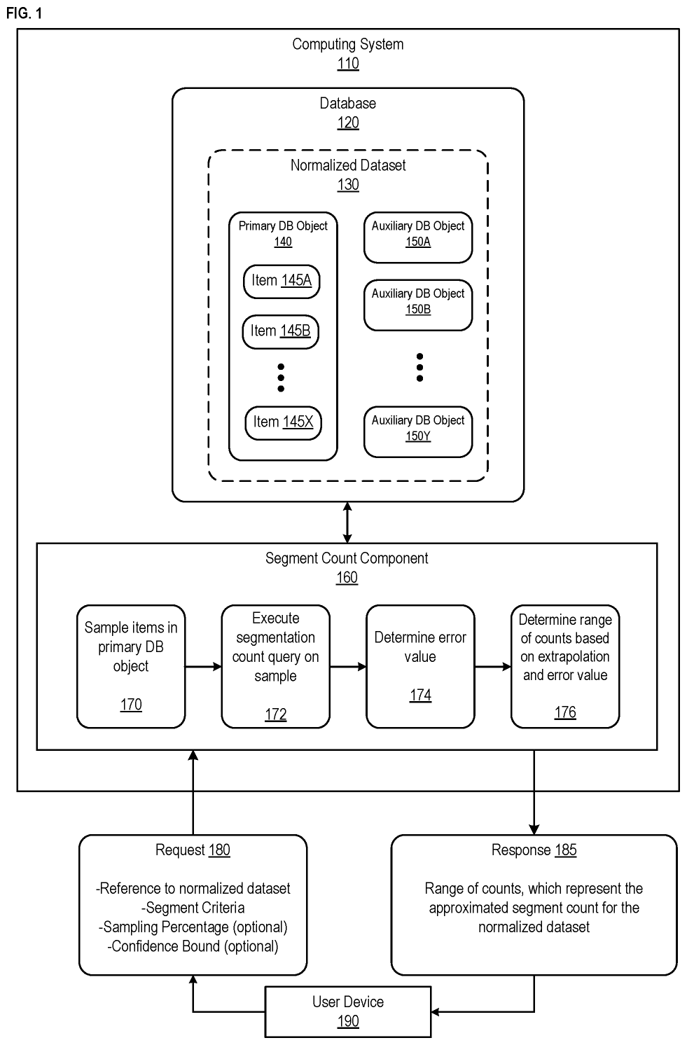

FIG. 1 is a block diagram showing an environment in which a segment count for a normalized dataset can be approximated using sampling, according to some implementations.

As shown in the diagram, the environment includes a computing system 110 and a user device 190. The computing system 110 includes a database 120 and a segment count component 160.

The database 120 may store a normalized dataset 130. The normalized dataset 130 may be organized using a primary database object 140 and one or more multiple auxiliary database objects 150. For example, as shown in the diagram, the normalized dataset 130 may be organized using primary database object 140 and auxiliary database objects 150A-Y. In an implementation, the primary database object 140 and the auxiliary database objects 150 are each relational database tables. The primary database object 140 may include one or more items 145. For example, as shown in the diagram, the primary database object 140 includes items 145A-X. Each item may represent a real-world entity or concept. For example, in the context of a CRM system, the items in the primary database object 140 may represent customers and/or prospective customers of a company. In an implementation, each item is stored as a record in the primary database object 140 (e.g., as rows in a relational database table), but other ways of storing items are possible. The auxiliary database objects 150 may include data relating to the items 145 in the primary database object 140. For example, continuing with the example described above, if the items represent customers and/or prospective customers of a company, the data in auxiliary database objects 150 may represent various information relating to the customers or prospective customers such as demographic information (e.g., gender, age, address/location, etc.), purchase history (e.g., what products/services the customer has purchased in the past), and/or online search history (e.g., what terms the customer has searched in an online search engine). In an implementation, each item 145 in the primary database object 140 is assigned a unique item ID. The primary database object 140 may include the unique item IDs and the auxiliary database objects 150 may refer to those item IDs to correlate the data in the auxiliary database objects 150 with the items in the primary database object 140 (e.g., the item ID may be a primary key in the primary database object 140 and be a foreign key in the auxiliary database object 150).

The segment count component 160 may implement a segment count service that can provide approximated segment counts to users in response to receiving requests from those users. A segment is a subset of items that satisfy a specified segment criteria. A segment count is the number items included in a segment. In an implementation, the segment count component 160 provides a graphical user interface (GUI) to the user device 190 that allows users operating user devices (e.g., a user operating user device 190) to submit requests for approximating segment counts to the segment count service over a network and that provides/displays approximated segment counts received from the segment count service over the network to the user. The GUI may be an interactive GUI that is displayed on a display of the user device 190 (e.g., which may allow the user to input the filter criteria). The user device 190 (and more specifically the client application running on the user device 190 that is used to access the segment count service) may be considered to be a client of the segment count service. In an implementation, the segment count component 160 is fully or partially implemented in the cloud (e.g., in a public or private cloud). For sake of simplicity, a single user device/client is shown in the diagram. It should be appreciated, however, that the environment may include additional user devices/clients that can access the segment count service provided by the segment count component 160.

In operation, the user device 190 may send a request 180 to approximate a segment count to the segment count component 160 on behalf of a user operating the user device 190. The request may include a reference to the normalized dataset 130 for the segment count and a set of segment criteria for the segment count. The set of segment criteria may include one or more criteria for the items that are to be included in the count. In an implementation, the request also includes a sampling percentage and/or a confidence level value. The sampling percentage may indicate the desired percentage of items in the primary database object 140 that are to be sampled for purposes of approximating the segment count. In general, a higher sampling percentage provides more accurate approximations but slower execution times, whereas a lower sampling percentage provides less accurate approximations but faster execution times. In an implementation, the sampling percentage is fixed/static or determined by segment count component 160 based on the size of the normalized dataset 130. In other implementations, the sampling percentage is configurable by the user (e.g., via a GUI for accessing the segment count service). In an implementation, the sampling percentage is between 5 percent and 15 percent. The confidence level value indicates a desired confidence level for the approximated segment count. In an implementation, the confidence level value corresponds to a z-score (e.g., a z-score of 1.96 may indicate a confidence level of 95%). As will be described in additional detail herein, the confidence level value may affect the size of the range of counts (which represents the approximated segment count) that is returned by the segment count component 160. In an implementation, the confidence level value is fixed/static or determined by the segment count component 160 based on the size of the normalized dataset 130. In other implementations, the confidence level value is configurable by the user (e.g., via a GUI for accessing the segment count service).

Responsive to receiving the request, the segment count component 160 may perform operations for approximating the segment count for the normalized dataset 130 for the specified set of segment criteria. In an implementation, approximating the segment count involves performing operations 172-176, which are further described below.

At operation 172, the segment count component 160 samples items in the primary database object 140 to generate a sample (e.g., a random sample). In an implementation, the segment count component 160 performs a sampling operation for each item in the primary database object 140 to determine whether the item is to be included in the sample or not. In an implementation, the segment count component 160 performs the sampling operation on a given item based on transforming an item ID of the item using a random string (which was generated based on a random seed) to generate a transformed item ID, applying a hash function to the transformed item ID to generate a hash value, applying a modulo operation to the hash value to generate a modulo value that is within a predefined range of values, and determining whether the item is to be included in the sample based on whether the modulo value is in a predefined subset of the predefined range of values. The predefined subset may include a number of values that corresponds to a sampling percentage multiplied by a total number of values in the predefined range of values. The sampling percentage may be predefined, determined based on the number of items in the primary database object 140, or provided by the user (e.g., in the request).

For example, the segment count component 160 may generate a random string based on a random seed and append the random string to the item ID to generate a transformed item ID. The segment count component 160 may then apply a hash function to the transformed item ID to generate a hash value and apply a modulo 100 operation to the hash value to generate a modulo value that is between 0 and 99. The segment count component 160 may determine whether the item is to be included in the sample or not based on the modulo value. Assuming that the sampling percentage is ten percent, modulo values between 0 and 9 (ten percent of the possible modulo values) may indicate that the item is to be included in the sample and modulo values between 10 and 99 (the other ninety percent of the possible modulo values) may indicate that the item is not to be included in the sample (it should be appreciated, however, that in other implementations, a different set of ten modulo values may indicate that the item is to be included in the sample and that the modulo values need not be consecutive (e.g., modulo values 30-39 or modulo values 1, 11, 21, 31, 41, 51, 61, 71, 81, and 91)—the sample size is expected to be similar regardless of which set of ten modulo values are used since the IDs are expected to be random and they are further randomized using a random seed). Thus, if the resulting modulo value is between 0 and 9, then the segment count component 160 may include the item in the sample, but otherwise not include the item in the sample. It is noted that due to the randomness, the number of items that are included in the sample may not be exactly ten percent of the total number of items (but it could be more or less than ten percent of the total number of items). While a particular way of generating a sample is described above, it should be appreciated that the sample can be generated in other ways.

An advantage offered by the randomization approach described above is that it is computationally inexpensive and repeatable across SQL engines. One conventional approach to randomization is to use the ORDER BY RANDOM feature of SQL. However, this approach is computationally expensive since it involves sorting the entire data. The randomization approach described above is less computationally expensive because it does not need to sort the entire data. Another conventional approach to randomization is to use the table sample application programming interface (API). However, this approach does not provide repeatability in certain SQL engines. The randomization approach described above provides repeatability (the same sample can be selected each time within a given query) since it generates one random seed per query, which is used to generate hashes that dictate whether an item is included in the sample or not. Also, since the random seed can be unique for each query, the samples are not repeated for different queries, which is a desirable property for the sampling algorithm. Repeatability is desired when there are multiple loads of the same database object within the same query to prevent divergence, and thus inaccuracy.

At operation 172, the segment count component 160 executes a segmentation count query on the sample. The segmentation count query is a query for counting the number of items that satisfy a specified segment criteria. Executing the segmentation count query may involve joining items in the primary database object 140 with data in one or more auxiliary database objects 150 (e.g., using a SQL JOIN clause), performing aggregation (e.g., using a SQL GROUP BY clause on the item ID and a SQL AGGREGATE function), filtering items based on the set of segment criteria (e.g., using a SQL WHERE clause), and counting the number of resulting items (e.g., using a SQL COUNT function). In an implementation, the segmentation count query specifies one or more sampling operations for sampling items in the primary database object 140. Thus, executing the segmentation count query may involve performing operation 170 (the sampling operation). In an implementation, the segmentation count query includes multiple sub-queries that each join the items in the primary database object 140 with data included in one or more of the auxiliary database object 150. In an implementation, the segmentation count query specifies a sampling operation for each sub-query (to sample items in the primary database object 140) and each sampling operation uses the same random seed to perform the same sampling. Thus, the same sampling may be repeated for each sub-query of the segmentation count query (the same items will be sampled from the primary database object 140 for each sub-query). Execution of the segmentation count query may return the number of items in the sample that satisfy the set of segment criteria. An example segmentation count query is provided below:

```
with ssot_{——}Individual_{——}temp as ( select * from ssot_{——}Individual_{——}dlm
  where abs(from_big_endian_64(xxhash64(CAST(ssot_{——}Id_{——}c || IF (KQ_Id_{——}c IS NULL, “,
KQ_Id_{——}c) || ‘1687427489’ AS varbinary))))% 100 < 10)
select distinct count(*)
from
  select
    alias_18027546.ssot_{——}Id_{——}c, alias_18027546.KQ_Id_{——}c
  from
    (
      select distinct ssot_{——}Individual_dlm_{——}0.ssot_{——}Id_{——}c, ssot_{——}Individual_{——}dlm_{——}0.KQ_{——}Id_{——}c
      from
        ssot_{——}Individual_{——}temp as ssot_{——}Individual_{——}dlm_{——}0
    ) as alias_18027546
    left outer join (
      select table2_{——}dlm_0.column_{——}c, table2_{——}dlm_{——}0.KQ_column_{——}c, table2_{——}dlm_{——}0.id_{——}c
as table2_{——}dlm_{——}0_{——}id_{——}c
      from
        table2_{——}dlm as table2_{——}dlm_0
      where lower(table2_{——}dlm_{——}0.column1_{——}c) = lower(‘3’)
) as alias_44154635 on (alias_44154635.column_{——}c = alias_18027546.ssot_{——}Id_{——}c
      and trim(cast(alias_44154635.column_{——}c as varchar)) <> ”
      and alias_44154635.KQ_column_{——}c is not distinct from alias_18027546.KQ_Id_{——}c
    )
  group by
    alias_18027546.ssot_{——}Id_{——}c, alias_18027546.KQ_Id_{——}c
  having count(alias_44154635.table2_{——}dlm_{——}0_{——}id_{——}c) >= cast(‘1.0’ as decimal(38, 18))
```

The example segmentation count query above generates a sampled view of the primary table using the “with” clause. This involves generating a random seed and using it to augment the ID, using the augmented ID to generate a hash and modulo it by 100 to get a number between 0 and 99 (inclusive), using one range to filter the IDs after applying the transformations (e.g., filtering the items with modulo value between 0 and 9 (inclusive), and generating the sample. The sampled view of the primary table can be used throughout the query wherever the original primary table was being used.

More generally, in some implementations, the segmentation count query follows the below pattern:

<Sample selection on primary table>

```
select distinct count(*) from (
  filter1 Sample_On_primary_table (optional join with other auxiliary tables)
  UNION/INTERSECT
  filter2 Sample_On_primary_table (optional join with other auxiliary tables)
...
)
```

At operation 174, the segment count component 160 determines an error value. The error value may represent the amount of error introduced due to sampling. In an implementation, the segment count component 160 determines the error value based on an estimated sample size of the sample, the number of items in the sample that satisfy the set of segment criteria, and a confidence level value. The estimated sample size of the sample may be determined as the number of items in the primary database object multiplied by the sampling percentage. For example, continuing with the example described above where the sampling percentage is ten percent, if the primary database object 140 includes 200 items, then the estimated sample size would be 20 items (200 items*10%=20 items). It is noted that the actual number of items that end up in the sample may be different from the estimated sample size due to the randomness involved with the sampling. Hence, the estimated sample size is merely an estimate. The number of items in the sample that satisfy the set of segment criteria may have been determined by executing the segmentation count query on the sample (operation 172). As mentioned above, the confidence level value indicates a desired confidence level for the approximated segment count. In an implementation, the confidence level value corresponds to a z-score (e.g., a z-score of 1.96 may indicate a 95% confidence level). As will be described in additional detail herein, the confidence level may affect the size of the range of counts determined in operation 176.

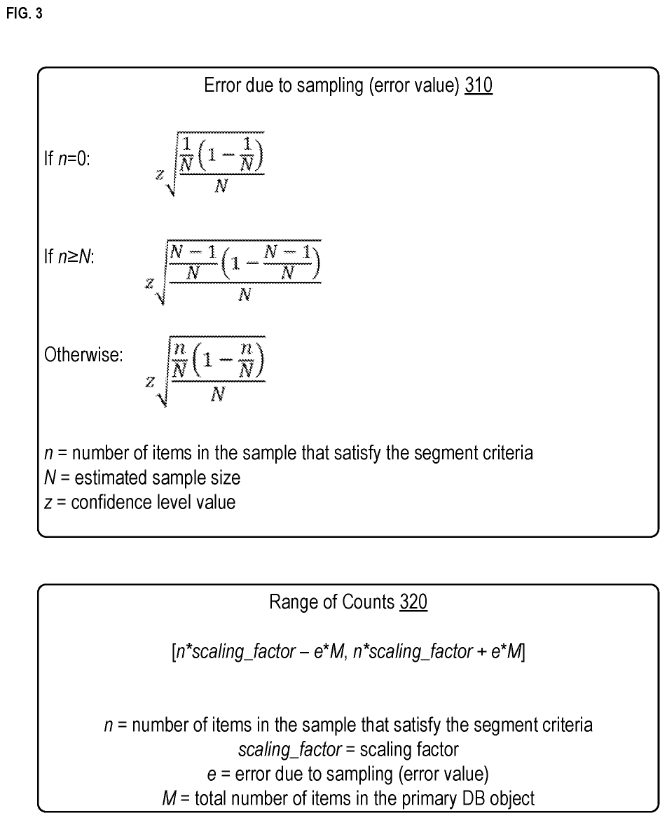

In an implementation, the segment count component 160 determines the error value differently depending on the number of items in the sample that satisfy the set of segment criteria. For example, as shown in FIG. 3, the segment count component 160 may determine the error value 310 differently depending on whether the number of items in the sample that satisfy the set of segment criteria is zero (n=0), greater than or equal to the estimated sample size (n>=N), or otherwise (0<n<N). It is noted that the number of items in the sample that satisfy the set of segment criteria may be greater than the estimated sample size due to the randomness involved in the sampling.

As shown in FIG. 3, when the number of items in the sample that satisfy the set of segment criteria is zero (n=0), the segment count component 160 may determine the error value 310 according to equation I. In the equations, e is the error value, n is the number of items in the sample that satisfy the set of segment criteria, N is the estimated sample size of the sample, and z is the confidence level value.

$$e = z \sqrt{\frac{\frac{1}{N} ( 1 - \frac{1}{N} )}{N}} \qquad Equation I$$

Also, as shown in FIG. 3, when the number of items in the sample that satisfy the set of segment criteria is greater than or equal to the estimated sample size (n>=N), the segment count component 160 may determine the error value 310 according to equation II:

$$e = z \sqrt{\frac{\frac{N - 1}{N} ( 1 - \frac{N - 1}{N} )}{N}} \qquad Equation II$$

Also, as shown in FIG. 3, when the number of items in the sample that satisfy the set of segment criteria is greater than zero but less than the estimated sample size (0<n<N), the segment count component 160 may determine the error value according to equation III:

$$e = z \sqrt{\frac{\frac{n}{N} ( 1 - \frac{n}{N} )}{N}} \qquad Equation III$$

Thus, if there are no items in the sample that satisfy the set of segment criteria, then n is essentially set to 1. Also, if the number of items in the sample that satisfy the set of segment criteria is greater than the estimated sample size, n is essentially set to N−1.

Returning to FIG. 1, at operation 176, the segment count component 160 determines a range of counts for the segment count based on the number of items in the sample that satisfy the set of segment criteria, the error value, and a total number of items in the primary database object. For example, as shown in FIG. 3, the segment count component 160 may determine the range of counts as follows:

$$[ n * scaling\_factor - e * M , n * scaling\_factor + e * M ]$$

In the above range, n is the number of items in the sample that satisfy the set of segment criteria, scaling_factor is the scaling factor, e is the error value, and M is the total number of items in the primary database object. The scaling factor may be the inverse of the sampling percentage (e.g., if the sampling percentage is 10%, then the scaling factor is 10 (1/0.1); if the sampling percentage is 20%, then the scaling factor is 5 (1/0.2)). The value of n was determined based on the sample. Multiplying n by scaling_factor extrapolates n to all items.

In an implementation, the confidence level indicates the probability that the actual segment count will lie within the range of counts. For example, if the confidence level is 95% (which corresponds to a z-score of 1.96), the probability that the actual segment count will lie within the range of counts determined in operation 176 is 95%. In general, the range of counts will be wider if the confidence level is higher (e.g., due to e becoming larger) and the range of counts will be narrower if the confidence level is lower (due to e becoming smaller).

Once the segment count component 160 determines the range of counts, it may send a response 185 corresponding to the request 180 to the user device 190. The response 185 may include the range of counts, which represents the approximated segment count for the normalized dataset for the set of segment criteria. The user device 190 may display the range of counts to the user operating the user device 190 (e.g., in a GUI provided by the segment count component 160).

As described herein above, implementations provide a segment count service that can quickly approximate a segment count for a normalized dataset for a specified segment criteria. In an implementation, the sampling percentage is configurable to allow the user of the segment count service to customize the tradeoff between the accuracy of the approximation and the speed of performing the approximation. Additionally or alternatively, in an implementation, the confidence level is configurable to allow the user of the segment count service to customize the confidence level of the approximation.

Experimentation results have shown that implementations can provide an over forty percent reduction in the time it takes to perform a segment count compared to approaches that do not use sampling. Also, implementations use significantly less computing resources such as central processing unit (CPU) and memory resources compared to approaches that do not use sampling. Some queries may involve joining the items in the primary database object 140 with data across multiple auxiliary database objects 150 (e.g., a chain of joins). The sampling/approximation techniques described herein can significantly reduce the amount of computation needed down the join path (e.g., because only the sampled items (instead of all items in the primary database object) need to be joined with the data in the auxiliary tables).

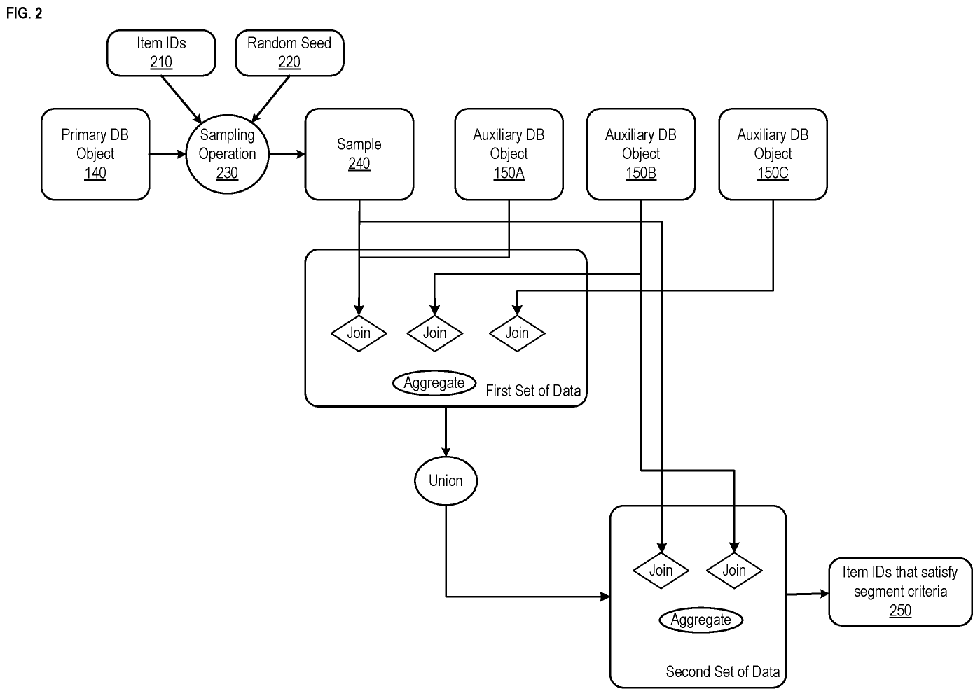

FIG. 2 is a diagram showing operations involved in executing a segmentation count query, according to some implementations.

As shown in the diagram, a sampling operation 230 may be applied to items in the primary database object 140 to generate a sample 240. The sampling operation 230 may select samples based on a list of item IDs 210 of the items in the primary database object 140 and a random seed 220. The items in the sample 240 may be joined with data included in auxiliary database object 150A, auxiliary database object 150B, and auxiliary database object 150C (e.g., using a SQL JOIN clause) and aggregated (e.g., using a SQL AGGREGATE function) to generate a first set of data. The items in the sample 240 may also be joined with data included in auxiliary database object 150B and aggregated to generate a second set of data. The first set of data and the second set of data may be combined (e.g., using a SQL UNION clause) to generate a combined dataset. The set of segment criteria may be applied to the combined dataset to determine which items satisfy the set of segment criteria. The query may return the items 250 that satisfy the set of segment criteria. It is noted that the same sample 240 may be used for different sub-queries (e.g., for the sub-query to generate the first set of data and the sub-query to generate the second set of data). Performing joins with the sample 240 instead of with all of the items in the entire primary database object 140 reduces the size of the first dataset and the second dataset, which in turn reduces the complexity of the aggregation, filter, and count operations, which in turn allows for faster query execution.

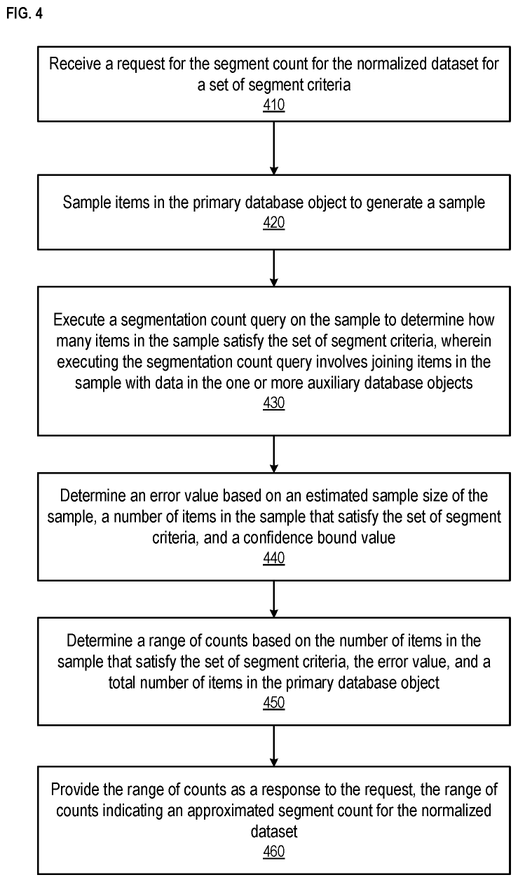

FIG. 4 is a flow diagram of a method for approximating a segment count for a normalized dataset using sampling, according to some implementations. In an implementation, the method is performed by a computing system that implements a segment count component 160 providing a segment count service. The method may be performed using hardware, software, firmware, or any combination thereof.

While the flow diagram shows a particular order of operations performed by certain implementations, such order is by way of example and not intended to be limiting (e.g., alternative implementations may perform the operations in a different order, combine certain operations, perform certain operations in parallel, overlap performance of certain operations such that they are partially in parallel, etc.).

At operation 410, the computing system receives a request for the segment count for the normalized dataset for a set of segment criteria.

At operation 420, the computing system samples items in the primary database object to generate a sample. In an implementation, sampling the items in the primary database object comprises performing a sampling operation for each of one or more items in the primary database object to determine whether the item is to be included in the sample or not. In an implementation, performing the sampling operation for an item comprises generating a random string based on a random seed, transforming an item ID of the item using the random string to generate a transformed item ID, applying a hash function to the transformed item ID to generate a hash value, applying a modulo operation to the hash value to generate a modulo value that is within a predefined range of values, and determining whether the item is to be included in the sample based on whether the modulo value is in a predefined subset of the predefined range of values. The predefined subset may include a number of values that corresponds to a sampling percentage multiplied by a total number of values in the predefined range of values.

At operation 430, the computing system executes a segmentation count query on the sample to determine how many items in the sample satisfy the set of segment criteria. Executing the segmentation count query may involve joining items in the sample with data in the one or more auxiliary database objects. In an implementation, the segment count query specifies a first sampling operation that uses a random seed for sampling the items in the primary database object. In an implementation, the segment count query further specifies a second sampling operation that uses the random seed to repeat a same sampling performed by the first sampling operation.

At operation 440, the computing system determines an error value based on an estimated sample size of the sample, a number of items in the sample that satisfy the set of segment criteria, and a confidence level value. In an implementation, the estimated sample size of the sample is determined as a number of items in the primary database object multiplied by a sampling percentage. In an implementation, the sampling percentage is configurable by a user and included in the request. In an implementation, the confidence level value corresponds to a z-score. In an implementation, when the number of items in the sample that satisfy the set of segment criteria is greater than zero but less than the estimated number of sampled items, the error value is determined according to equation III provided herein above. In an implementation, when the number of items in the sample that satisfy the set of segment criteria is zero, the error value is determined according to equation I provided herein above. In an implementation, when the number of items in the sample that satisfy the set of segment criteria is equal to or greater than the estimated number of sampled items, the error value is determined according to equation II provided herein above.

At operation 450, the computing system determines a range of counts for the segment count based on the number of items in the sample that satisfy the set of segment criteria, the error value, and a total number of items in the primary database object.

At operation 460, the computing system provides the range of counts as a response to the request, the range of counts representing an approximated segment count for the normalized dataset. In an implementation, the range of counts is determined to be as follows:

$$[ n * scaling\_factor - e * M , n * scaling\_factor + e * M ]$$

In the above range, n is the number of items in the sample that satisfy the set of segment criteria, scaling_factor is the scaling factor, e is the error value, and M is the total number of items in the primary database object.

### Databases

Databases may be implemented according to a variety of different database models, such as relational, non-relational, graph, columnar (also known as extensible record; e.g., HBase), object, tabular, tuple store, and multi-model. Examples of non-relational database models (which may also be referred to as schema-less and NoSQL database models) include key-value store and document store (also known as document-oriented as they store document-oriented information, which is also known as semi-structured data). A database may comprise one or more database objects that are managed by a database management system (DBMS), each database object may include a number of records, and each record may comprise a set of fields. A record may take different forms based on the database model being used and/or the specific database object to which it belongs; for example, a record may be: 1) a row in a table of a relational database; 2) a JavaScript Object Notation (JSON) object; 3) an Extensible Markup Language (XML) document; 4) a key-value pair; etc. A database object can be unstructured or have a structure defined by the DBMS (a standard database object) and/or defined by a user (a custom database object). In some implementations of a cloud database (a database that runs on a cloud platform and that is provided as a database service), identifiers are used instead of database keys, and relationships are used instead of foreign keys. While implementations may use one or more types of databases, a relational database with tables is sometimes described to simplify understanding. In a relational database management system (RDBMS), each relational database table (which is a type of database object) generally contains one or more data categories logically arranged as columns according to a schema, where the columns of the relational database table are different ones of the fields from the plurality of records, and where rows of the relational database table are different ones of a plurality of records and each contains an instance of data for each category defined by the fields. Thus, the fields of a record are defined by the structure of the database object to which the record belongs; e.g., a CRM database may include a table that describes a customer with fields for contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields.

### Customer Relationship Management (CRM)

Customer relationship management (CRM) is a term that refers to practices, strategies, and/or technologies that companies (e.g., vendors) use to manage and analyze customer interactions and data throughout the customer lifecycle, with the goal of improving customer relationships, customer retention, and sales growth. A CRM system is designed to compile information about customers across different channels (e.g., points of contact between the customer and the company such as the company's website, telephone, live chat, direct mail, marketing materials, and social media, etc.). A CRM system can also give customer-facing staff detailed information about a particular customer's personal information, purchase history, buying preferences, and concerns.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, machine, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these example scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

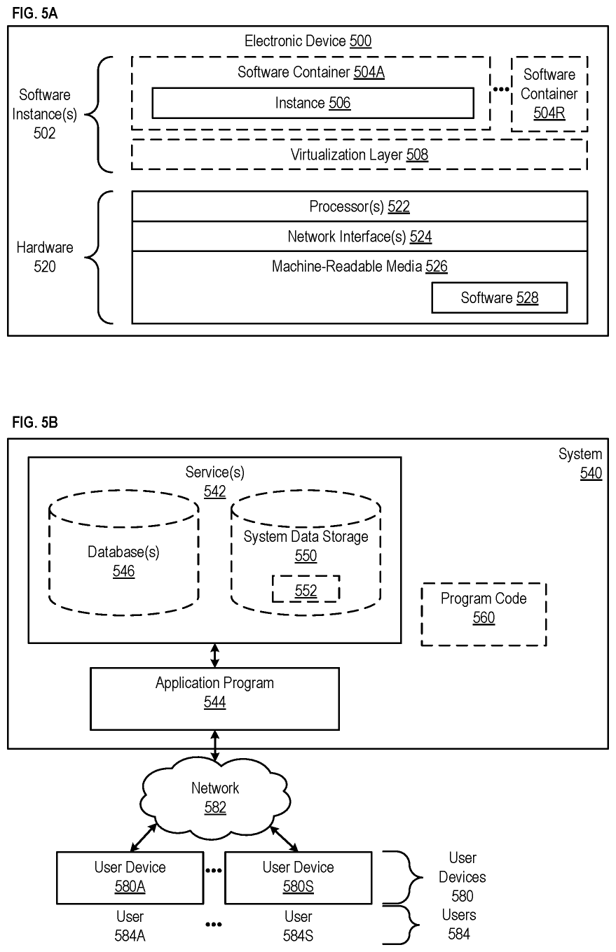

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and machine-readable media 526 having stored therein software 528 (which includes instructions executable by the set of one or more processor(s) 522). The machine-readable media 526 may include non-transitory and/or transitory machine-readable medium/media. Each of the previously described clients and the segment count service may be implemented in one or more of electronic device 500. In one implementation: 1) each of the clients is implemented in a separate one of the electronic device 500 (e.g., in end user devices where the software 528 represents the software to implement clients to interface directly and/or indirectly with the segment count service (e.g., software 528 represents a web browser, a native client, a portal, a command-line interface, and/or an application programming interface (API) based upon protocols such as Simple Object Access Protocol (SOAP), Representational State Transfer (REST), etc.)); 2) the segment count service is implemented in a separate set of one or more of electronic device 500 (e.g., a set of one or more server devices where the software 528 represents the software to implement the segment count service); and 5) in operation, the electronic devices implementing the clients and the segment count service would be communicatively coupled (e.g., by a network) and would establish between them (or through one or more other layers and/or or other services) connections for submitting requests for segment count approximations to the segment count service and returning responses including approximated segment counts (e.g., ranges of counts) to the clients. Other configurations of electronic devices may be used in other implementations (e.g., an implementation in which the client and the segment count service are implemented on a single one of electronic device 500).

During operation, an instance of the software 528 (illustrated as instance 506 and referred to as a software instance; and in the more specific case of an application, as an application instance) is executed. In electronic devices that use compute virtualization, the set of one or more processor(s) 522 typically execute software to instantiate a virtualization layer 508 and a set of one or more software containers, shown as software container 504A to software container 504R (e.g., with operating system-level virtualization, the virtualization layer 508 may represent a container engine (such as Docker® Engine container runtime by Docker, Inc. or Red Hat® OpenShift container runtime by Red Hat, Inc.) running on top of (or integrated into) an operating system, and it allows for the creation of multiple software containers (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 528 is executed within the software container 504A on the virtualization layer 508. In electronic devices where compute virtualization is not used, the instance 506 on top of a host operating system is executed on the “bare metal” electronic device 500. Instances of the software 528, as well as the virtualization layer 508 and the software containers if implemented, are collectively referred to as software instance(s) 502.

Alternative implementations of an electronic device may have numerous variations from that described above. For example, customized hardware and/or accelerators might also be used in an electronic device.

### Example Environment

FIG. 5B is a block diagram of a deployment environment according to some example implementations. A system 540 includes hardware (e.g., a set of one or more server devices) and software to provide service(s) 542, including the segment count service. In some implementations the system 540 is in one or more datacenter(s). These datacenter(s) may be: 1) first party datacenter(s), which are datacenter(s) owned and/or operated by the same entity that provides and/or operates some or all of the software that provides the service(s) 542; and/or 2) third-party datacenter(s), which are datacenter(s) owned and/or operated by one or more different entities than the entity that provides the service(s) 542 (e.g., the different entities may host some or all of the software provided and/or operated by the entity that provides the service(s) 542). For example, third-party datacenters may be owned and/or operated by entities providing public cloud services (e.g., Amazon Web Services® service by Amazon.com, Inc., Google Cloud Platform™ service by Google LLC, Azure® service by Microsoft Corporation).

The system 540 is coupled to user devices 580 (shown as user device 580A to user device 580S) over a network 582. The service(s) 542 may be on-demand services that are made available to users 584 (shown as user 584A to user 584S) working for one or more entities other than the entity which owns and/or operates the on-demand services (those users sometimes referred to as outside users) so that those entities need not be concerned with building and/or maintaining a system, but instead may make use of the service(s) 542 when needed (e.g., when needed by the users). The service(s) 542 may communicate with each other and/or with one or more of the user devices 580 via one or more APIs (e.g., a REST API). In some implementations, the user devices 580 are operated by the users 584, and each may be operated as a client device and/or a server device. In some implementations, one or more of the user devices 580 are separate ones of the electronic device 500 or include one or more features of the electronic device 500.

In some implementations, the system 540 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant typically includes a group of users with access to at least some of the same data/functionality with the same or similar privileges/permissions. Tenants may be different entities (e.g., different companies, different departments/divisions of a company, and/or other types of entities), and some or all these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all the vendors' data. As another example, in the context of Platform as a Service (PAAS), one set of tenants may be third-party application developers providing applications/services and another set of tenants may be customers of different ones or all the third-party application developers.

Multi-tenancy can be implemented in different ways. In some implementations, a multi-tenant architecture may include software instance(s) that are shared by multiple tenants (e.g., a single database instance share by multiple tenants, sometime referred to as a multi-tenant database; a single application instance shared by multiple tenants, sometimes referred to as a multi-tenant application; a single application instance and a single database instance shared by multiple tenants; an application instance per tenant and a database instance shared by multiple tenants; a single application instance share by multiple tenants and a database instance per tenant).

In one implementation, the system 540 is a multi-tenant cloud computing architecture supporting multiple services, such as one or more of the following types of services: segment count service 542, Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM).

For example, system 540 may include an application platform 544 that enables PAAS for creating, managing, and executing one or more applications developed by the provider of the application platform 544, users accessing the system 540 via one or more of the user devices 580, or third-party application developers accessing the system 540 via one or more of user devices 580.

In some implementations, one or more of the service(s) 542 may use one or more database(s) 546 and/or system data storage 550 (which stores system data 552). In certain implementations, the system 540 includes a set of one or more servers that are running on server electronic devices and that are configured to handle requests for any authorized user associated with any tenant (there is no server affinity for a user and/or tenant to a specific server). The user devices 580 communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the database(s) 546 and/or system data storage 550.

In some implementations, the service(s) 542 are implemented using virtual applications dynamically created at run time responsive to queries from the user devices 580 and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including the segment count service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 5rd Generation Partnership Project (5GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 540 and the user devices 580.

Each of the user devices 580 (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 540. For example, the user interface device can be used to access data and applications hosted by system 540, and to perform searches on stored data, and otherwise allow one or more of users 584 to interact with various GUI pages that may be presented to the one or more of users 584. The user devices 580 may communicate with system 540 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more the user devices 580 may include an HTTP client, commonly referred to as a “browser,” for sending and receiving HTTP messages to and from server(s) of system 540, thus allowing one or more of the users 584 to access, process and view information, pages and applications available from system 540 over network 582.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is provided by way of example and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A method performed by a computing system to approximate a segment count for a normalized dataset, wherein the normalized dataset is organized using a primary database object and one or more auxiliary database objects, the method comprising:
receiving a request for the segment count for the normalized dataset for a set of segment criteria;
sampling items in the primary database object to generate a sample;
executing a segmentation count query on the sample to determine how many items in the sample satisfy the set of segment criteria, wherein executing the segmentation count query involves joining items in the sample with data in the one or more auxiliary database objects;
determining an error value based on an estimated sample size of the sample, a number of items in the sample that satisfy the set of segment criteria, and a confidence level value;
determining a range of counts for the segment count based on the number of items in the sample that satisfy the set of segment criteria, the error value, and a total number of items in the primary database object; and
providing the range of counts as a response to the request, the range of counts representing an approximated segment count for the normalized dataset.

2. The method of claim 1, wherein sampling the items in the primary database object comprises performing a sampling operation for each of one or more items in the primary database object to determine whether the item is to be included in the sample or not.

3. The method of claim 2, wherein performing the sampling operation for an item comprises:
generating a random string based on a random seed;
transforming an item identifier (ID) of the item using the random string to generate a transformed item ID;
applying a hash function to the transformed item ID to generate a hash value;
applying a modulo operation to the hash value to generate a modulo value that is within a predefined range of values; and
determining whether the item is to be included in the sample based on whether the modulo value is in a predefined subset of the predefined range of values, the predefined subset including a number of values that corresponds to a sampling percentage multiplied by a total number of values in the predefined range of values.

4. The method of claim 1, wherein the estimated sample size of the sample is determined as a number of items in the primary database object multiplied by a sampling percentage.

5. The method of claim 4, wherein the sampling percentage is configurable by a user and included in the request.

6. The method of claim 1, wherein the confidence level value corresponds to a z-score.

7. The method of claim 1, wherein when the number of items in the sample that satisfy the set of segment criteria is greater than zero but less than the estimated number of sampled items, the error value is determined according to the following formula:
$$z \sqrt{\frac{\frac{n}{N} ( 1 - \frac{n}{N} )}{N}}$$
wherein n is the number of items in the sample that satisfy the set of segment criteria, N is the estimated sample size of the sample, and z is the confidence level value.

8. The method of claim 7, wherein when the number of items in the sample that satisfy the set of segment criteria is zero, the error value is determined according to the following formula:
$$z \sqrt{\frac{\frac{1}{N} ( 1 - \frac{1}{N} )}{N}}$$
wherein N is the estimated sample size of the sample and z is the confidence level value.

9. The method of claim 8, wherein when the number of items in the sample that satisfy the set of segment criteria is equal to or greater than the estimated number of sampled items, the error value is determined according to the following formula:
$$z \sqrt{\frac{\frac{N - 1}{N} ( 1 - \frac{N - 1}{N} )}{N}}$$
wherein N is the estimated sample size of the sample and z is the confidence level value.

10. The method of claim 1, wherein the segment count query specifies a first sampling operation that uses a random seed for sampling the items in the primary database object.

11. The method of claim 10, wherein the segment count query further specifies a second sampling operation that uses the random seed to repeat a same sampling performed by the first sampling operation.

12. A non-transitory machine-readable storage medium that provides instructions that, if executed by a processor of a computing system, are configurable to cause said computing system to perform operations for approximating a segment count for a normalized dataset, wherein the normalized dataset is organized using a primary database object and one or more auxiliary database objects, the operations comprising:
receiving a request for the segment count for the normalized dataset for a set of segment criteria;
sampling items in the primary database object to generate a sample;
executing a segmentation count query on the sample to determine how many items in the sample satisfy the set of segment criteria, wherein executing the segmentation count query involves joining items in the sample with data in the one or more auxiliary database objects;
determining an error value based on an estimated sample size of the sample, a number of items in the sample that satisfy the set of segment criteria, and a confidence level value;
determining a range of counts for the segment count based on the number of items in the sample that satisfy the set of segment criteria, the error value, and a total number of items in the primary database object; and
providing the range of counts as a response to the request, the range of counts representing an approximated segment count for the normalized dataset.

13. The non-transitory machine-readable storage medium of claim 12, wherein sampling the items in the primary database object comprises performing a sampling operation for each of one or more items in the primary database object to determine whether the item is to be included in the sample or not.

14. The non-transitory machine-readable storage medium of claim 12, wherein performing the sampling operation for an item comprises:
generating a random string based on a random seed;
transforming an item identifier (ID) of the item using the random string to generate a transformed item ID;
applying a hash function to the transformed item ID to generate a hash value;
applying a modulo operation to the hash value to generate a modulo value that is within a predefined range of values; and
determining whether the item is to be included in the sample based on whether the modulo value is in a predefined subset of the predefined range of values, the predefined subset including a number of values that corresponds to a sampling percentage multiplied by a total number of values in the predefined range of values.

15. The non-transitory machine-readable storage medium of claim 12, wherein the estimated sample size of the sample is determined as a number of items in the primary database object multiplied by a sampling percentage.

16. The non-transitory machine-readable storage medium of claim 12, wherein when the number of items in the sample that satisfy the set of segment criteria is greater than zero but less than the estimated number of sampled items, the error value is determined according to the following formula:
$$z \sqrt{\frac{\frac{n}{N} ( 1 - \frac{n}{N} )}{N}}$$
wherein n is the number of items in the sample that satisfy the set of segment criteria, N is the estimated sample size of the sample, and z is the confidence level value.

17. An apparatus comprising:
a processor; and
a non-transitory machine-readable storage medium that provides instructions that, if executed by the processor, are configurable to cause the apparatus to perform operations for approximating a segment count for a normalized dataset, wherein the normalized dataset is organized using a primary database object and one or more auxiliary database objects, the operations comprising:
receiving a request for the segment count for the normalized dataset for a set of segment criteria;
sampling items in the primary database object to generate a sample;
executing a segmentation count query on the sample to determine how many items in the sample satisfy the set of segment criteria, wherein executing the segmentation count query involves joining items in the sample with data in the one or more auxiliary database objects;
determining an error value based on an estimated sample size of the sample, a number of items in the sample that satisfy the set of segment criteria, and a confidence level value;
determining a range of counts for the segment count based on the number of items in the sample that satisfy the set of segment criteria, the error value, and a total number of items in the primary database object; and
providing the range of counts as a response to the request, the range of counts representing an approximated segment count for the normalized dataset.

18. The apparatus of claim 17, wherein sampling the items in the primary database object comprises performing a sampling operation for each of one or more items in the primary database object to determine whether the item is to be included in the sample or not.

19. The apparatus of claim 17, wherein performing the sampling operation for an item comprises:
generating a random string based on a random seed;
transforming an item identifier (ID) of the item using the random string to generate a transformed item ID;
applying a hash function to the transformed item ID to generate a hash value;
applying a modulo operation to the hash value to generate a modulo value that is within a predefined range of values; and
determining whether the item is to be included in the sample based on whether the modulo value is in a predefined subset of the predefined range of values, the predefined subset including a number of values that corresponds to a sampling percentage multiplied by a total number of values in the predefined range of values.

20. The apparatus of claim 17, wherein when the number of items in the sample that satisfy the set of segment criteria is greater than zero but less than the estimated number of sampled items, the error value is determined according to the following formula:
$$z \sqrt{\frac{\frac{n}{N} ( 1 - \frac{n}{N} )}{N}}$$
wherein n is the number of items in the sample that satisfy the set of segment criteria, N is the estimated sample size of the sample, and z is the confidence level value.
